(19) United States
(12) Patent Application Publication
(10) Pub. No.: US 2023/0144722 A1
(43) Pub. Date: May 11, 2023

(54) PACING TRAINING SYSTEM

(71) Applicants: Carlton I. Silver, Fort Washington, PA (US); Andrew E. Houriet, Newtown, PA (US)

(72) Inventors: Carlton I. Silver, Fort Washington, PA (US); Andrew E. Houriet, Newtown, PA (US)

(21) Appl. No.: 17/454,468

(22) Filed: Nov. 10, 2021

(51) Int. Cl. A63B 71/06; A63B 69/00; F21S 8/00; G07C 1/24; A63B 24/00

(52) U.S. Cl. CPC A63B 71/0622; A63B 69/0028; F21S 8/032; G07C 1/24; A63B 24/0021; A63B 71/0686; A63B 2225/02; A63B 2225/50; A63B 2225/74; A63B 2071/0694; A63B 2071/0625; F21Y 2115/10

(57) ABSTRACT

A pacing system signals runners with lights indicating if the runner is ahead or behind a preset pace as the runner proceeds around a running track. The system includes a controller that provides pace setting, start, stop, pause, and reset functions; pacing stations (e.g., 20) that are placed at intervals around the running track; and a cart for transport and battery charging. Paces are setup in the controller with a specific number of laps and a time per lap. Bright LED lights in LED matrices in the pacing stations signal the runners outdoors in sunlight. The controller wirelessly communicates with the pacing stations to signal the pacing stations to light at intervals determined by the preset pace. The system may support two or more simultaneous paces and variable pacing per lap to accommodate multiple runners.

### TECHNICAL FIELD

This patent application describes a pacing training system for training of track athletes and, more particularly, a pacing training system that signals runners with lights indicating whether they are ahead or behind a preset pace as the runners proceed around the track.

### BACKGROUND

Presently, when track athletes train for mid-distances or long distances, there is no reliable, consistent method for reproducible modeling of appropriate pacing while training. Typically, more experienced runners act as leaders at practices. These “pace setters” enable other runners to develop the feel for a given pace or timing, i.e., what it feels like to run a 55 second lap versus a 65 or 70 second lap, etc. The goal of the use of a pace setter is, through multiple approximated pace runs and training sessions, to develop muscle memory for a given pace and to, with training, to improve upon these times with the goal of lowering the times and improving consistency.

Typically, coaches help runners by calling out times as the runners circle the track by yelling every 10 seconds, etc. However, this does not allow the runner to know where they should be at any given time. It only tells them how long they have been running. It would be beneficial to runners during training if, while they were running, they had visual confirmation or representation of where on the track they should be at any given time to maintain a given pace that would accomplish the desired lap speed.

For example, it would be helpful to runners if a computerized sweeping timing line were displayed on the track where the sweeping line of light would teach and demonstrate any given pace more consistently. Such an approach would be similar to what can be seen while watching Olympics swimmers chasing the world record in a given event where a superimposed timing line across the pool on the television broadcast mimics the pace of the world record time. Of course, such a timing line is not seen by the swimmers and thus is not helpful to the swimmers while training.

To provide pacing guidance to runners, a continuous ring of lights may be provided to ring the track and to provide lighting on or adjacent the track that can be perceived by the runners. For example, Kline describes in U.S. Pat. No. 10,905,932 a track runner pacing system that paces a runner around a running track at a set pace with a moving visual light cue provided by one or more light strips positioned in sight of the running lances of the running track. The light strip includes a plurality of light elements that are sequentially lighted to make it appear as if a single light source is moving along the track at a set pace. The runner may carry a transmitter that enables the runner to dynamically update the pace. However, retrofitting a running track to include the light strips is cumbersome, difficult to set up, and prohibitively expensive.

Another option that has been proposed is to use a computerized pacing car that would circle the track at preset speeds, much like the rabbit at a dog track. However, the packing car is a physical impediment that could potentially trip and injure a runner.

A pacing system is desired that is easier to build, transport, and set up and that is safe and relatively inexpensive.

### SUMMARY

Various examples are now described to introduce a selection of concepts in a simplified form that are further described below in the Detailed Description. The Summary is not intended to be used to limit the scope of the claimed subject matter.

Instead of providing a continuous sweeping track of lights as described by Kline in U.S. Pat. No. 10,905,932, a pacing system is provided for track athlete training that uses a plurality of individual lights (e.g., 15-20) that are evenly spaced around the inside of the running track to provide a visual/lighted pace on the running track for the runners to chase. The lights are coordinated or programmed to light sequentially at a preset timing to provide the desired pace for the lap. A recording may call out the pacing at set intervals to replicate the encouragement by the track coach.

The pacing system described herein signals runners with lights indicating if the runner is ahead or behind the pace as the runner proceeds around the running track. The system includes a controller that provides pace setting, start, stop, pause, and reset functions; pacing stations (e.g., 20) that are placed at intervals around the running track; and a cart for transport and battery charging. Paces are setup in the controller with a specific number of laps and a time per lap. Bright LED lights in LED matrices in the pacing stations signal the runners outdoors in sunlight. The controller wirelessly communicates with the pacing stations to signal the pacing stations to light at intervals determined by the preset pace. The system may support two or more simultaneous paces and variable pacing per lap to accommodate multiple runners. The entire system may be battery powered.

This summary section is provided to introduce aspects of the inventive subject matter in a simplified form, with further explanation of the inventive subject matter following in the text of the detailed description. The particular combination and order of elements listed in this summary section is not intended to provide limitation to the elements of the claimed subject matter. Rather, it will be understood that this section provides summarized examples of some of the embodiments described in the Detailed Description below.

### BRIEF DESCRIPTION OF THE DRAWINGS

The foregoing and other beneficial features and advantages of the invention will become apparent from the following detailed description in connection with the attached figures, of which:

FIG. 1 illustrates an example wireless controller of an example pacing system.

FIG. 2 illustrates an example pacing station that is placed at intervals adjacent the track.

FIG. 3 illustrates placement of the pacing stations at even intervals around the running track for training.

FIG. 4 illustrates a flow chart of the operation of the controller during setup and run modes.

FIGS. 5A-5G illustrate sample displays of the controller during setup of the pacing stations, and FIG. 5H illustrates a sample display of the controller during training.

FIG. 6 illustrates a flow chart of the operation of the pacing stations during the setup and run modes.

FIG. 7A illustrates the magnetic attachment of a metal frame to the enclosure of the pacing stations for use as a stand.

FIG. 7B illustrates the pacing station in the stand ready for use.

FIG. 8 illustrates an example carrying/charging cart for the controller and pacing stations.

FIG. 9 illustrates a sample computer configuration for the processors in the controller and pacing stations in example configurations.

### DETAILED DESCRIPTION

Embodiments of the pacing system described herein may be understood more readily by reference to the following detailed description taken in connection with the accompanying figures and examples that form a part of this disclosure. It is to be understood that this description is not limited to the specific products, methods, conditions, or parameters described and/or shown herein, and that the terminology used herein is for the purpose of describing particular embodiments by way of example only and is not intended to be limiting of any claimed subject matter. Similarly, any description as to a possible mechanism or mode of action or reason for improvement is meant to be illustrative only, and the subject matter described herein is not to be constrained by the correctness or incorrectness of any such suggested mechanism or mode of action or reason for improvement. Throughout this text, it is recognized that the descriptions refer both to methods and systems/software for implementing such methods.

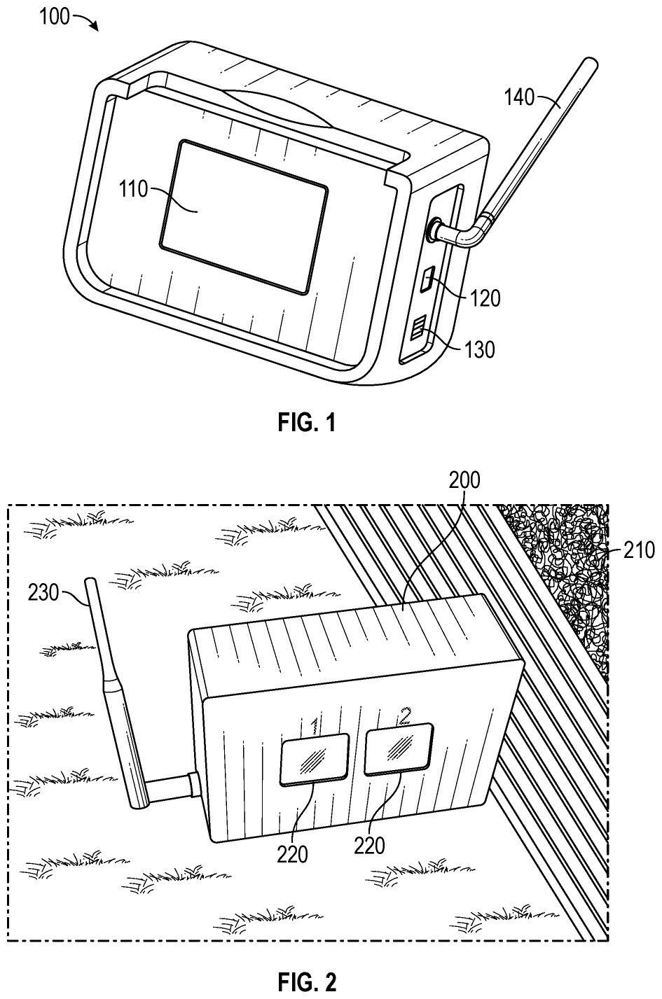

A detailed description of illustrative embodiments will now be described with reference to FIGS. 1-9. Although this description provides a detailed description of possible implementations, it should be noted that these details are intended to be exemplary and in no way delimit the scope of the inventive subject matter.

The pacing system described herein provides a more reliable way for runners to train. The portable pacing system provides a reliably reproducible pacing that is easier to learn. By providing visual lighting cues along with the simultaneous announcement of the times while the runner is running, development of the runner's performance may be reliably enhanced. The pacing system provides reproducible modeling of speed pacing for runners who are training at any running distances. Through paced runs, athletes may develop muscle memory for a given speed and then, with training, lower their times while improving their consistency.

In sample configurations, pacing light units are spaced evenly around a track to provide sequential visual cues that help the athletes learn their pace. Each athlete may maintain their pace by matching the visual cue of illumination of colored lights on the pacing stations as they pass the respective pacing stations. The lights thus enhance training by providing an accurate, reproducible and adjustable method of training for any desired pace.

As illustrated in FIG. 1, the pacing system includes a portable wireless controller 100 that includes a color touch screen display 110, a USB charge port 120, a power switch 130, and an antenna 140. The controller 100 is sized to be handheld for easy user operation. As will be explained in more detail below, the controller 100 allows the user to select the desired pacing, to start and stop the pacing, and to wirelessly broadcast control signals to the respective pacing stations.

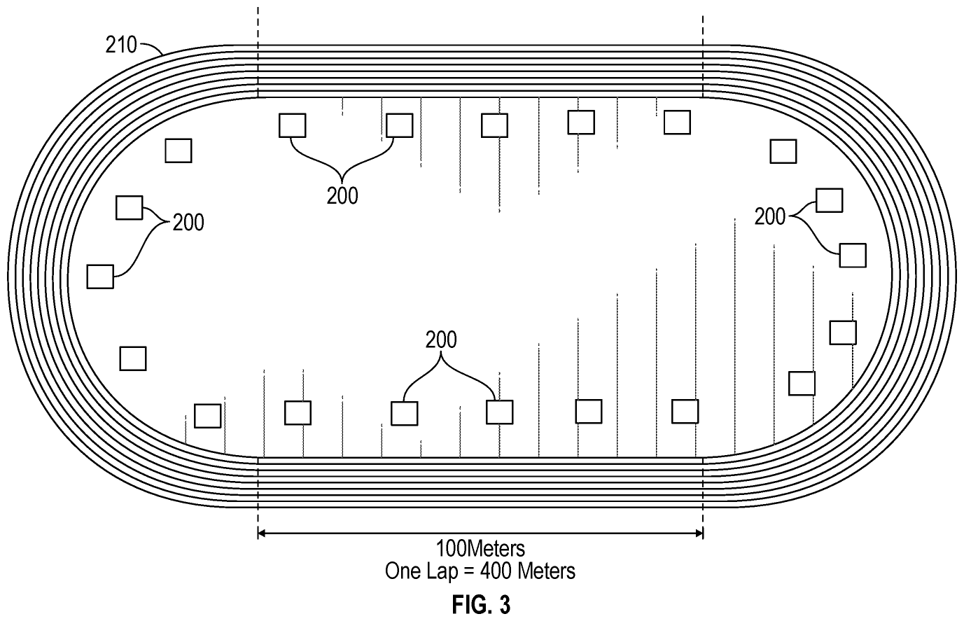

FIG. 2 illustrates a sample pacing station 200 that is placed at intervals adjacent the track 210. The pacing station includes respective LED matrices 220 for providing respective lighting signals for representing the pacing to the runners. The illustrated example shows two LED matrices 220 for providing two paces, but it will be appreciated that more (or only one) LED matrices 220 may be provided to accommodate multiple paces for multiple runners. The antenna 230 enables the pacing station to communicate with the controller 100 for establishing the pace timing.

During operation, the user starts by placing the pacing stations 200 at even intervals around the running track as shown in FIG. 3 and activating each pacing station 200. In this example, 20 pacing stations 200 are placed every 20 meters around a 400 meter track. Of course, more or less pacing stations may be used, as desired.

A rotary measuring tool may be used to measure the 20 meter increments around the track. The track is setup by putting pacing station 200 at the starting line, then measuring 20 meter increments and placing the remaining pacing stations 200, from 1-19 around the track. It may be useful to mark the locations with tape or paint for subsequent training sessions.

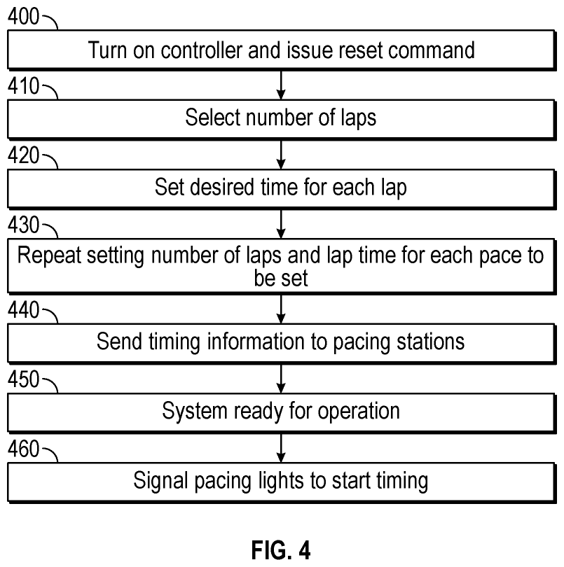

Setup of the controller 100 will be described with reference to FIG. FIG. 4.

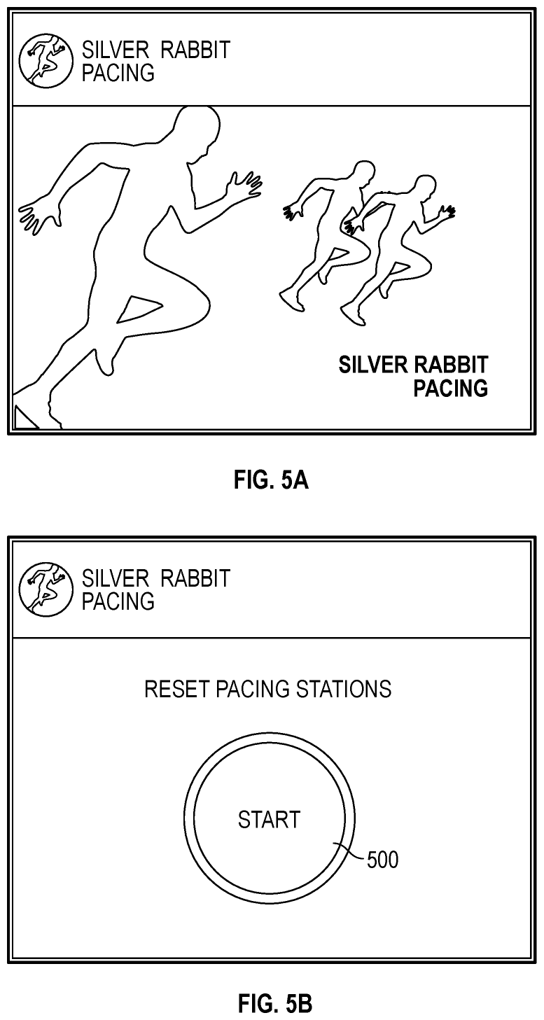

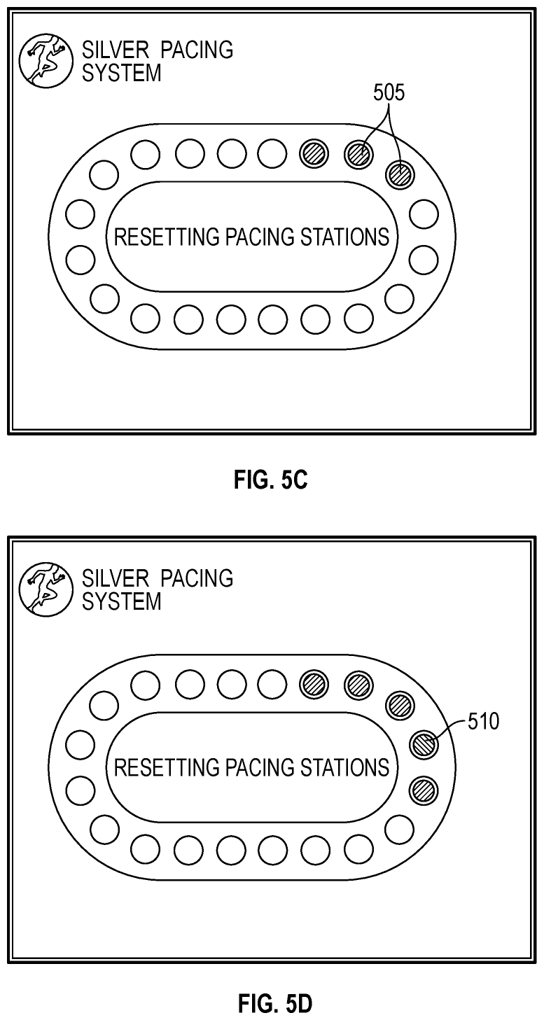

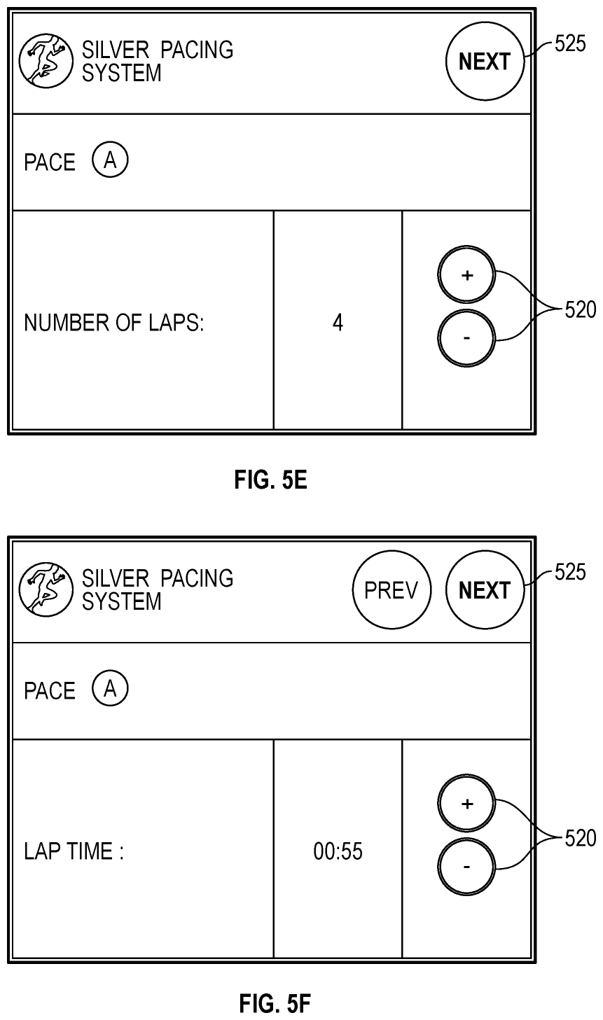

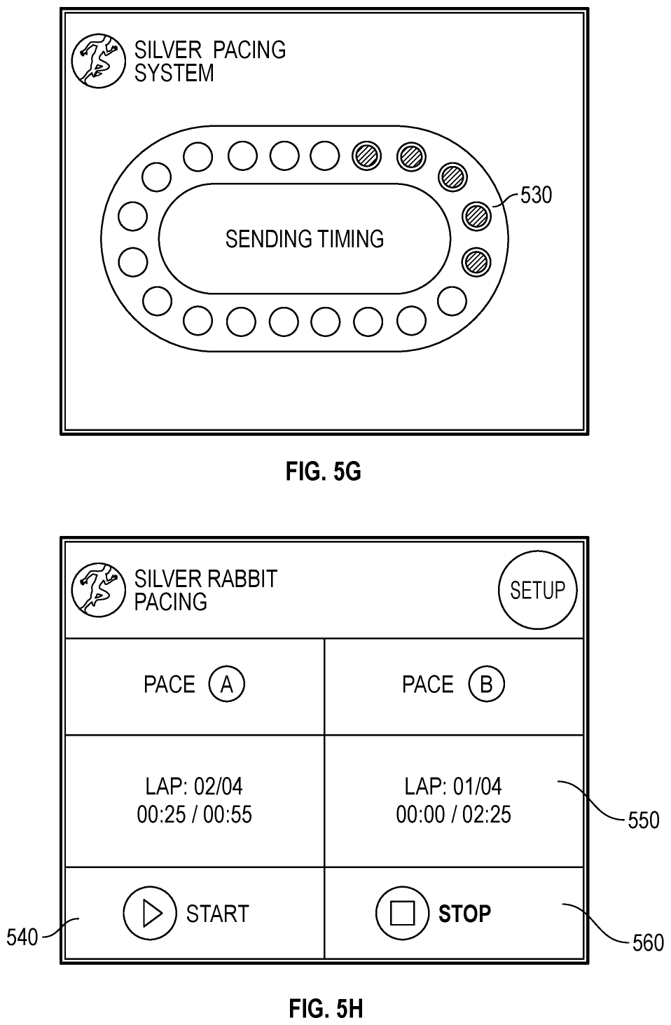

At step 400, the controller 100 is turned on and the system is reset by touching the START button 500 (FIG. 5B) to cause the controller 100 to issue a reset command to reset the respective stations 200. The user then selects the number of laps at 410 and sets the desired time for each lap (e.g., 55 seconds) at 420. Selection of the number of laps and the desired time for each lap is repeated for each additional preset pace, as needed, at 430. The controller 100 sends the timing information to the pacing stations 200 at 440. Optionally, the pacing stations 200 may blink the pacing lights to show that they have received the timing information and are in an idle status. The system is now ready for operation at 450.

During a training session, the runners line up for start. The runners start and the Start button 500 is pressed on the controller 100 at 460, and the controller 100 signals the pacing lights of the respective pacing stations 200 to start timing. The pacing lights start their timing cycle, displaying their lights as appropriate. For example, the first pacing station 200 after the starting line will display its pacing light at 1/20^{th} of the pacing interval (assuming that 20 pacing stations 200 are being used), the second pacing station 200 after the starting line will display its pacing light at 2/20^{th} of the pacing interval, and so forth.

As the runners proceed around the track, each pacing station 200 will blink its light more quickly as it reaches the proper pace time for that position on the track. Once the pacing station 200 reaches its time point, the light will be turned on steadily. This way, the runner will know where they are relative to the pace. In a sample configuration, if the runner reaches a given pacing station:
Light is still blinking—the runner is ahead of the pace;
Light turns solid as the runner passes—the runner is on pace; and
Light turns solid before the runner passes—the runner is behind pace.

As noted above, the controller 100 is a hand-held device that is battery operated and can be recharged when not in use (or during use). The controller 100 functions include setting the pace timings, starting and stopping the timing process, resetting the entire system, and sending control signals, polling, and tracking presence of each pacing unit over a wireless connection. The controller 100 is adapted to handle setup and operation of at least two paces. In a sample configuration, the respective paces are designated by different color lights on the pacing stations 200. For example, the paces may be designated as A (red) and B (green), where the LED matrices 220 of the respective pacing stations 200 are red and green for the A and B paces, respectively.

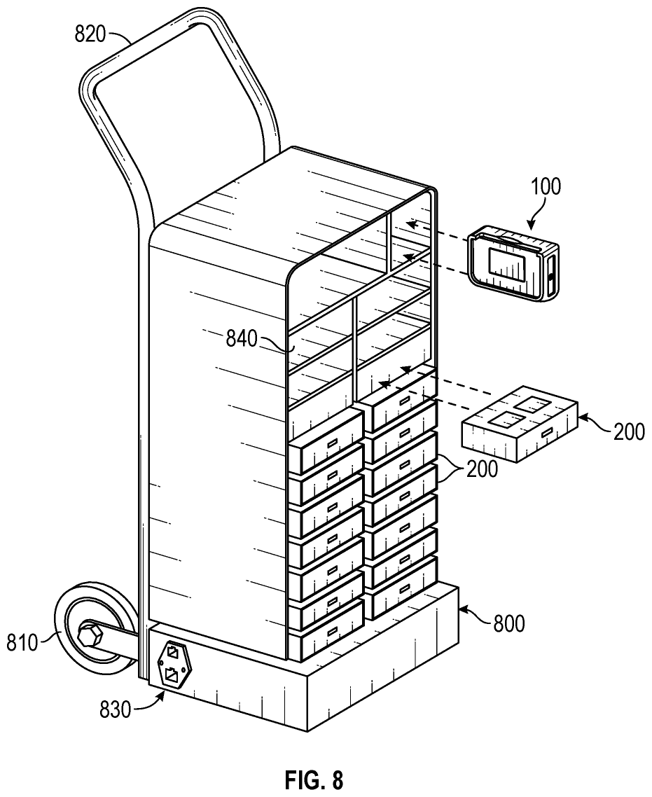

In a sample configuration, the controller 100 includes a waterproof plastic box with a rechargeable battery mounted inside capable of, for example, 12 hours of continuous use. Charging is through a standard micro-USB port 160, which is connected to the charging station (FIG. 8) via a power switch. The display 110 may be a 320×240 LCD screen with a capacitive touchscreen and 16-bit color landscape format. The display 110 will automatically turn off after a number of seconds of idle/non-use. Touching the display screen 110 will turn it back on. The wireless connection may be implemented as a 915 MHz packet radio, low-power multi-node network. In such case, the controller 100 may include a wireless module (e.g., RFM69, 915 MHz, Packet Radio) and an external antenna 170. The controller 100 may further include a central processing unit (CPU) (e.g., ATS AMD 21G18 ARM Cortex M0 processor) that executes instructions for performing the functionality described herein. In sample configurations, the controller 100 does not communicate with the pacing stations 200 while the timers are running, only to send commands during setup.

The controller 100 has a Setup mode and a Run mode. In Setup mode, the laps count and lap times are set, as described above. In Run mode, the lap timers will run for each pace that has been set in the Setup mode.

In Setup mode, the controller 100 provides an interface to setup the lap timings and counts, start and stop the pacing, and reset all pacing stations. Since the controller 100 will most frequently be used outdoors, the colors of the LCD display screen 110 are selected for use in bright sunlight as well as cloudy/darker conditions. The display screen 110 will dim and turn off after a period of inactivity. For example, after 30 seconds of inactivity, the display screen 110 will dim to 50%. After 10 more seconds of inactivity, the display screen 110 will turn off. During inactivity, any touch will bring the display screen 110 back, but touch will be ignored in any user interface screen.

During setup, the controller 100 will show an introduction/splash screen of the type shown in FIG. 5A. For setup, the user will be prompted to initiate a reset/poll of all pacing stations 200 as shown in FIG. 5B. The user touches the Start button 500 to begin the time synchronization to each pacing station 200. The display 110 may show the reset progress/process as shown in FIG. 5C. During the reset, each station 200 is sent a reset command to reset and store the network time. If the acknowledgement to the reset command is received, the display 100 will light up in green as shown at 505 in FIG. 5C. However, if the acknowledgement is not received after multiple retries, the display 100 will light up in red as shown at 510 in FIG. 5D. If this happens, the reset process will be rerun.

Once the pacing stations 200 have been reset, the user selects the number of laps for pace A. In an example, the default lap count is 2, the minimum lap count is 1, and maximum lap count is 12. Up and down arrow buttons 520 may be used to increase/decrease the lap count as shown in FIG. 5E. The user selects the next button 525 to continue.

Next, the user selects the lap time in minutes and seconds. In an example, the default lap time is 55 seconds, a minimum lap time is 10 seconds, and a maximum lap time is 120 minutes. As shown in FIG. 5F, the user presses the up and down arrows buttons 520 to set the minutes or seconds value. The user selects the next button 525 to continue.

The process of setting the number of laps and lap time in minutes and seconds is repeated for pace B and any additional paces.

Once the laps and lap timing has been set, the controller 100 sends the timing settings to each of the pacing stations 200. The station count increases as the pacing stations 200 respond to the timing settings. As shown in FIG. 5G, if the acknowledgement to the timing command is received, the display 110 will light up in green as shown at 530 in FIG. 5G. However, if the acknowledgement is not received after multiple retries, the display 110 will light up in red as shown at 510 in FIG. 5D. If this happens, the timing settings will be resent. The controller 100 sends timing settings to all pacing stations 200. Once all pacing stations 200 have responded, the setup is complete. The controller 100 is now ready for the start of the training.

In Run mode, the Start button 540 is pressed to start the timing in coordination with the start of the runners. The timer will count up to the lap time, then increment the lap count for each lap. The timing display during the running/timing process shows the current lap count and timing for each pace at 550 as shown in FIG. 5H.

The Stop button 560 is pressed to stop a pacing session for any reason. Otherwise, the controller 100 will stop at the end of each pacing cycle and will return to the ready position. Pressing the Stop button 560 again will reset both paces, starting with setup of pace A.

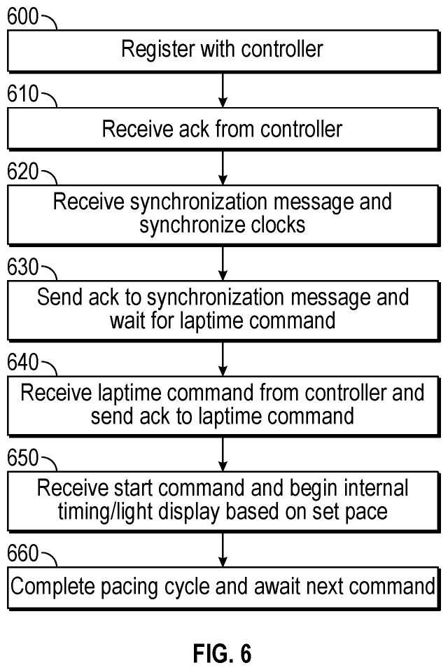

FIG. 6 illustrates a flow chart of the operation of the pacing stations during the setup and run modes.

When the pacing stations 200 power up, they will register with the controller 100 at 600. In response to receiving the registration message from a pacing station 200, the controller 100 sends an acknowledgement message that the pacing station receives at 610. The controller 100 sends a clock synchronization message to the pacing station 200 that the pacing station 200 receives at 620. The pacing station 200 sends an acknowledgement at 630. The clock synchronization message is sent for each pacing station 200 as each pacing station powers up.

The wireless messages between the controller 100 and pacing stations 200 follow a standard message/acknowledge protocol. The controller 100 sends a message and will expect an acknowledgement from each pacing station 200 for the messages sent to each pacing station 200. On the other hand, broadcast messages to not expect or receive an acknowledgement. In a sample configuration, the communications between the controller 100 and the pacing station 200 include the following

| Message | Parameters | Direction | Description |
|---|---|---|---|
| REGISTER | Station ID | To Station | Register a pacing station, send specific |
| | (1-20) | | station number. This will also synchronize |
| | | | the time on the pacing stations. |
| | Network | | |
| | time | | |
| LAPTIME | Station ID | To Stations | Sends the lap time for each pace to all pacing |
| | (1-20) | | stations. |
| | Pace A | | |
| | seconds | | |
| | Pace B | | |
| | seconds | | |
| START | Current | Broadcast to | Tells all pacing stations to start timing. |
| | time | Stations | |
| STOP | Current | Broadcast to | Tells all pacing stations to stop timing. |
| | time | Stations | |
| RESET | Current | Broadcast to | Tells all pacing stations to reset and await |
| | time | Stations | LAPTIME command. |
| ACK | Station ID | To Controller | Response to all commands from controller. |
| | (1-20) | | |
| IDENTIFY | Station ID | To Controller | Sent from pacing station to identify itself. |
| | (1-20) | | |
| SYNCH | Current | Broadcast to | Sent to all stations to synchronize time. |
| | time | Stations | |

In a sample configuration, the pacing stations 200 (FIG. 2) are a series of 20 boxes spaced 20 meters apart on the track. Each pacing station 200 has at least two large LED matrices (e.g., 8×8 LEDs) 220, one for each pace. In sample configurations, one LED matrix 220 is red and another is green to indicate the timing for each pace. Once the pacing starts, each pacing station 200 will blink the indicators for each pace. As the time for the runner reaches 20 meters distance, that pace indicator will flash until the timing point where the runner should be passing that pacing station 200. At that time, the indicator will stay on steadily for 10 to 15 seconds. The LEDS of the LED matrices 220 are selected for good visibility in bright sunlight.

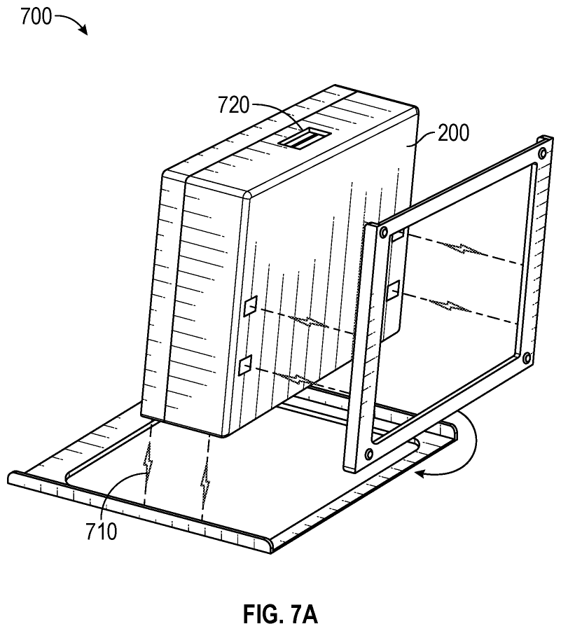

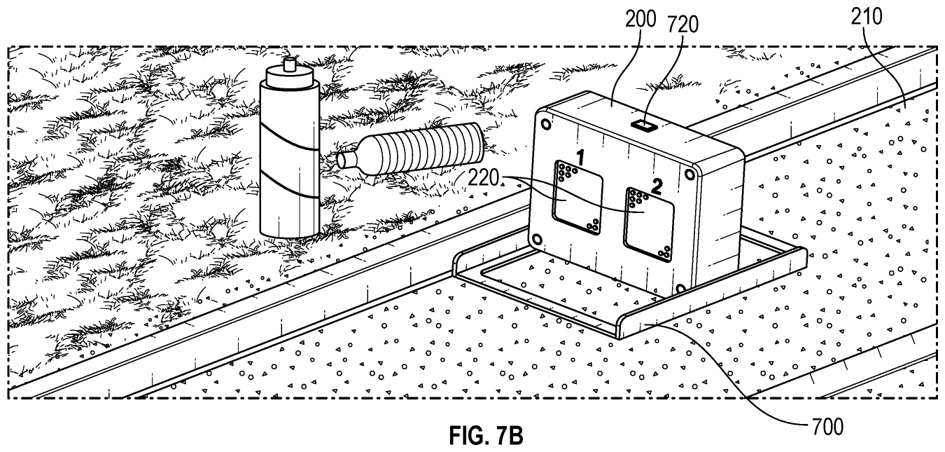

As shown in FIG. 7, the enclosure of the pacing stations 200 may have a metal frame 700 that attaches to the back of the pacing station 200 magnetically and can be removed and attached magnetically at 710 to use as a stand. The enclosure attaches to the metal frame with magnets for safety. In the event that someone falls or otherwise hits the enclosure, it will break away from the metal stand 700 readily. FIG. 7B shows the pacing station 200 in stand 700 ready for use.

The pacing stations 200 include a USB charging port 720 for charging internal rechargeable batteries. The pacing stations 200 are also waterproof for outdoor use.

The pacing stations 200 each include a central processing unit (CPU) (e.g., ATS AMD 21G18 ARM Cortex M0 or an Arduino UNO processor), a wireless module (e.g., RFM69, 915 MHz, Packet Radio), an external antenna 230, a red LED array (A) and green LED array (B) 220, a rechargeable battery, a battery charging circuit, a unit select DIP switch, and a power switch. At least one of the pacing stations 200 may be adapted to include one or more speakers for calling out the elapsed race time.

The pacing stations 200 have no user operation function. The pacing stations 200 are placed around the track at 20 meter intervals with a first station 20 meters from the starting line.

An internal setting DIP switch (not shown) may control the station identification numbers (1-20) as shown by the station number setting below. The pacing stations 200 must be placed in order around the track 210 for the timing to work correctly. Each pacing station 200 may be marked on the outside with its station number.

### Station Number Settings

| Station | Switch 1 | 2 | 3 | 4 | 5 |
|---|---|---|---|---|---|
| 1 | On | Off | Off | Off | Off |
| 2 | Off | On | Off | Off | Off |
| 3 | On | On | Off | Off | Off |
| 4 | Off | Off | On | Off | Off |
| 5 | On | Off | On | Off | Off |
| 6 | Off | On | On | Off | Off |
| 7 | On | On | On | Off | Off |
| 8 | Off | Off | Off | On | Off |
| 9 | On | Off | Off | On | Off |
| 10 | Off | On | Off | On | Off |
| 11 | On | On | Off | On | Off |
| 12 | Off | Off | On | On | Off |
| 13 | On | Off | On | On | Off |
| 14 | Off | On | On | On | Off |
| 15 | On | On | On | Off | Off |
| 16 | Off | Off | Off | Off | On |
| 17 | On | Off | Off | Off | On |
| 18 | Off | On | Off | Off | On |
| 19 | On | On | Off | Off | On |
| 20 | Off | Off | On | Off | On |

Two LED indicators may be provided on the side of each pacing station 200, one is a power indicator and the other is the battery charging indicator. When the pacing station 200 is in the charging rack (powered on) and the charging LED is on, the internal battery is charging. The LED will turn off when the battery is fully charged.

When each pacing station 200 is powered on, the radio network is initialized and the default lap time is set to 30 for 8 laps. The pacing station 200 reads its DIP switch settings for identification. The pacing station 200 alternately blinks the A/B LEDs to count up to the station number and to show proper operation.

Referring back to FIG. 6, A REGISTER message may be sent to the controller 100 by the pacing stations 200 randomly every 10-15 seconds at 600 to tell the controller 100 that the respective pacing station 200 is ready. Upon receipt of the ACK message from the controller 100 at 610, the LEDs are turned off and the pacing station waits for a SYNCH command from the controller 100. The clocks are synchronized upon receipt of the SYNCH command at 620. The pacing station 200 sends an acknowledgement at 630 and waits for a LAPTIME command from the controller 100. If the message is a LAPTIME command, the pacing station 200 resets the specified pace, sets the number of laps, and sets the time for each lap. A flash indicator for the corresponding LED matrix 220 is enabled for the specified pace. When the LAPTIME command is received at 640, the pacing station 200 alternatively blinks the LED matrices 220 three times and sends an ACK command. The pacing station 200 then waits for a START command from controller 100. When the START command is received at 650, the pacing station 200 adjusts internal timing for clock delay and begins internal timing/light display based on the set pace. The pacing station 200 completes the pacing cycle at 660 and awaits the next command.

When the pacing station 200 receives a message, if the message is PACE_CONNECT or PACE_SEND_PACES, a return acknowledge (Ack) is sent to the controller 100. If the message is any other broadcast message, the pacing station 200 checks if the message is a repeat and only processes the message if the same message is not received within 3 seconds. The pacing station 200 then processes each message. For example, if the next message is a RESET command, the pacing station 200 resets each pace and sets the network time to the controller time. The pacing station 200 also may flash the pace indicator. Then, upon receipt of a START command, the pacing station 200 starts the timing for the specified pace. However, if a STOP command is received at any time, the pacing station 200 stops the timing for the specified pace.

While a pace is running, each pacing station 200 calculates its timing based on its station number. Based on the calculation, the pacing station 200 begins flashing the pace indicator on the LED matrix 220 when the runner should be 20 meters before the station according to the set pace. The pace indicator is held steady when the runner should be at the pacing station 200 according to the set pace. When the runner is calculated to be 20 meters past the pacing station 200 based on the set pace, the pace indicator is turned off. The pacing station 200 may then calculate the timing for the next lap. If the current lap is the last lap, the pacing station 200 may move to idle and await the next command from controller 100. All calculations are done based on the station number, lap time of the current lap, and the network timing latency.

At least one of the pacing stations 200 may include at least one speaker and be programmed to announce elapsed race time in conjunction with the light displayed by each LED matrix 220 of each pacing station 200. The timing may be called out every 5 or 10 seconds and at one minute call “1” then continue again at 10, 20, 30 seconds until two minutes have elapsed and then call “2” and again repeat at 10 second intervals with the minutes called in succession for as long as programmed or just continuously.

A carrying/charging cart may also be provided to provide a place to store and transport the controller 100 and pacing stations 200. An example carrying/charging cart is shown in FIG. 8. As illustrated, the carrying/charging cart 800 may include a hand truck including wheels 810 and a handle 820 for easy mobility. The carrying/charging cart 800 contains a charging system for all of the devices. The charging system is rechargeable and may be plugged into an AC or DC source at power inlet 830 and include circuitry for providing a 5V DC power supply. The carrying/charging cart 800 is designed with compartments 840 for the controller 100 and each of the pacing stations 200. Each compartment 840 includes a floating connector on the back wall that serves as the charging connection.

The carrying/charging cart 800 thus includes a hand truck including wheels 810 and handle 820, a component rack including compartments 840, a 5V power supply, USB charging cables for the controller 100, a power inlet 830 and a switch, a power cable, and a roller measuring tool. The carrying/charging cart 800 may also be designed to include waterproof charging components.

### Computer Architecture

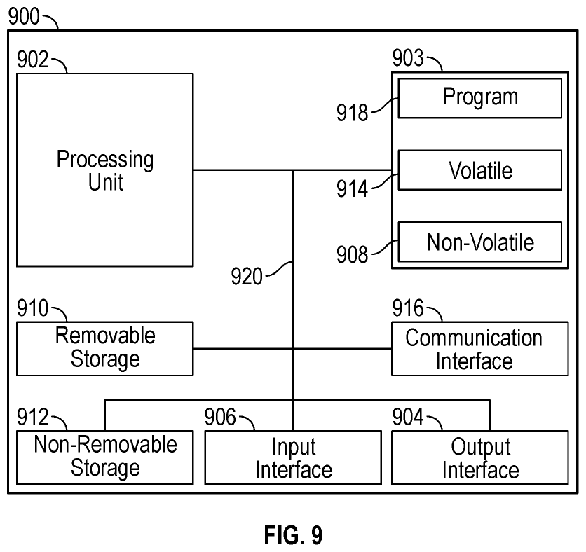

FIG. 9 is a block diagram illustrating circuitry in the form of a processing system for implementing the processing components of the controller 100 and/or the pacing stations 200 of the pacing system as described above with respect to FIGS. 1-8. All components need not be used in various examples. One example computing device in the form of a computer 900 may include a processing unit 902, memory 903, removable storage 910, and non-removable storage 912. Although the example computing device is illustrated and described as computer 900, the computing device may be in different forms in different configurations. Further, although the various data storage elements are illustrated as part of the computer 900, the storage may also or alternatively include cloud-based storage accessible via a network, such as the Internet or server-based storage.

Memory 903 may include volatile memory 914 and non-volatile memory 908. Computer 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes input interface 906, output interface 904, and a wireless communication interface 916. Output interface 904 may include a display device, such as a touchscreen, that also may serve as an input device. The input interface 906 may include one or more of a touchscreen, touchpad, mouse, keyboard, camera, one or more device-specific buttons, one or more sensors integrated within or coupled via wired or wireless data connections to the computer 900, and other input devices.

The computer 900 may operate in a networked environment using a communication connection to connect to one or more remote computers, such as database servers. The remote computer may include a personal computer (PC), server, router, network PC, a peer device or other common DFD network switch, or the like. The communication connection may include a Local Area Network (LAN), a Wide Area Network (WAN), cellular, Wi-Fi, Bluetooth, or other networks. According to one embodiment, the various components of computer 900 are connected with a system bus 920.

Computer-readable instructions stored on a computer-readable medium are executable by the processing unit 902 of the computer 900, such as a program 918. The program 918 in some embodiments comprises software that, when executed by the processing unit 902, performs operations according to any of the configurations included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 918 may be used to cause processing unit 902 to perform one or more methods or algorithms described herein.

Although a few configurations have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above with reference to any one or all of steps of the disclosure can be installed in and sold with one or more computing devices consistent with the disclosure. Alternatively, the software can be obtained and loaded into one or more computing devices, including obtaining the software through physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code or instructions to perform functions (e.g., by operating on input data and/or generating an output). Method steps can also be performed by, and apparatus for performing the methods can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors 902, such that the instructions, upon execution by one or more processors 902 cause the one or more processors 902 to perform any one or more of the methodologies described herein. Accordingly, a “machine-readable medium” refers to a single storage apparatus or device, as well as “cloud-based” storage systems that include multiple storage apparatus or devices.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the scope disclosed herein.

Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed:

1. A pacing system that signals runners with lights indicating if a runner is ahead or behind a preset pace as the runner proceeds around a running track, comprising:
a controller that is adapted to accept inputs for setting a pace in a setup mode and an input for starting a pace setting in a run mode, and a wireless transceiver that transmits pacing information; and
a plurality of pacing stations that are placed at intervals around the running track and include lights that light sequentially at respective pacing stations around the running track based on a set pace, wherein each pacing station includes a wireless transceiver that receives the pacing information from the controller.

2. The pacing station as in claim 1, wherein the lights in the respective pacing stations blink as a runner is expected to approach the pacing station based on the set pace and turn on steadily when the runner is expected to reach the pacing station based on the set pace.

3. The pacing system as in claim 1, wherein the controller accepts inputs for designating a number of laps and a time per lap for the set pace.

4. The pacing system as in claim 1, wherein the controller accepts inputs for setting at least two paces and respective pacing stations comprise different lights for each pace.

5. The pacing system as in claim 1, wherein the controller includes a start button that starts the pace setting in the run mode upon pressing of the start button.

6. The pacing system as in claim 1, wherein the respective pacing stations comprise a matrix of LED lights for each set pace.

7. The pacing station as in claim 1, wherein the controller wirelessly communicates with respective pacing stations to signal a light of the pacing stations to blink or turn on steadily based on the set pace and a distance of the respective pacing station from a starting line on the running track.

8. The pacing station as in claim 1, further comprising a metal frame for each respective pacing station that attaches to a case of the respective pacing station magnetically and breaks away from the respective pacing station upon contact.

9. The pacing station as in claim 1, wherein at least one of the pacing stations comprises a speaker to announce elapsed race time.

10. The pacing station as in claim 1, further comprising a cart that transports the controller and pacing stations and provides battery charging of the controller and pacing stations.

11. A method of pacing at least one runner as the at least one runner proceeds around a running track, comprising:
accepting inputs for setting at least one pace, the inputs including a number of laps and a desired time for each lap for each pace;
wirelessly transmitting pacing information for the at least one pace to each of a plurality of pacing stations that are placed at intervals around the running track; and
as the at least one runner proceeds around the running track, sequentially lighting lights at respective pacing stations around the running track based on the at least one set pace.

12. The method claim 11, wherein sequentially lighting lights at the respective pacing stations comprises causing the lights at the respective pacing stations to blink as the at least one runner is expected to approach a respective pacing station based on the at least one set pace and causing the lights at the respective pacing station to turn on steadily when the at least one runner is expected to reach the respective pacing station based on the set pace.

13. The method of claim 11, further comprising lighting lights of different colors for each pace at the respective pacing stations.

14. The method of claim 11, wherein sequentially lighting lights at the respective pacing stations comprises causing lights at the respective pacing stations to blink or turn on steadily based on the set pace and a distance of the respective pacing stations from a starting line on the running track.

15. The method of claim 1, further comprising placing the respective pacing stations in a metal frame for each respective pacing station that attaches to a case of the respective pacing station magnetically and breaks away from the respective pacing station upon contact.

16. The method of claim 11, further comprising at least one of the pacing stations announcing an elapsed race time.

17. The method of claim 11, comprising a controller that accepts the inputs for setting the at least one pace, further comprising synchronizing a timing of the controller and the respective pacing stations.

18. The method claim 11, further comprising transporting and charging the pacing stations using a cart having electrical charging outlets for each pacing station.

19. A non-transitory computer readable medium comprising instructions that when executed by at least one processor cause the at least one processor to implement a method of pacing at least one runner as the at least one runner proceeds around a running track, the method comprising:
accepting inputs for setting at least one pace, the inputs including a number of laps and a desired time for each lap for each pace;
wirelessly transmitting pacing information for the at least one pace to each of a plurality of pacing stations that are placed at intervals around the running track whereby, as the at least one runner proceeds around the running track, lights are sequentially lighted at respective pacing stations around the running track based on the at least one set pace; and
initiating pace timing by the respective pacing stations.

20. The medium claim 19, wherein initiating the pace timing causes the lights at the respective pacing stations to blink as the at least one runner is expected to approach a respective pacing station based on the at least one set pace and the lights at the respective pacing station to turn on steadily when the at least one runner is expected to reach the respective pacing station based on the set pace.
